(19) United States
(12) Patent Application Publication
(10) Pub. No.: US 2013/0219739 A1
(43) Pub. Date: Aug. 29, 2013

(54) DEVICE AND METHOD FOR DRYING FIBROUS MATERIAL

(71) Applicants: Franz Petschauer, Lannach (AT); Stefan Hansen, Graz (AT); Klaus Poeschl, Graz (AT)

(72) Inventors: Franz Petschauer, Lannach (AT); Stefan Hansen, Graz (AT); Klaus Poeschl, Graz (AT)

(73) Assignee: ANDRITZ AG, Graz (AT)

(21) Appl. No.: 13/881,251

(22) PCT Filed: Oct. 13, 2011
(86) PCT No.: PCT/AT2011/000425

§ 371 Date: Apr. 24, 2013

(30) Foreign Application Priority Data
Oct. 27, 2010 (AT) A 1782/2010

(51) Int. Cl. F26B 5/14

(52) U.S. Cl. CPC F26B 5/14
USPC 34/398; 34/143

(57) ABSTRACT

A method for dewatering a fibrous material web, wherein fibrous material is applied via a headbox on at least one wire and is subsequently dewatered in order to form a fibrous material web. Following the wire section, the resulting fibrous material web is dewatered by several presses, wherein the first press through which the fibrous material web is guided following the headbox is equipped with a double nip. The first press is formed by a wire roll and two couch rolls which are each pressed against the wire roll for forming a nip. Also disclosed is a corresponding device for carrying out the method.

The subject matter of this invention is formed by a method for dewatering a fibrous web, fibrous material for the formation of a fibrous web being applied via a headbox to at least one wire and being dewatered. Following the wire section, the fibrous web is guided through a plurality of presses and is dewatered. The subject matter of the invention is also formed by a device for carrying out the method according to the invention.

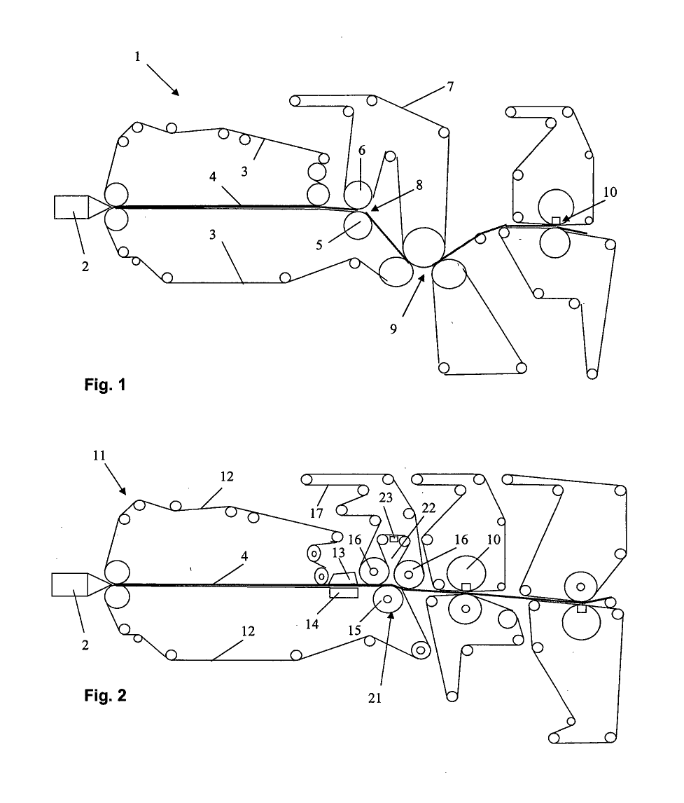

A conventional device for dewatering fibrous material is disclosed in WO99/66122 in FIG. 1. In this device, a fibrous stock suspension is applied via a headbox to a wire, and a fibrous web is formed in the process. Following this, the fibrous web is dewatered by a first press, what is known as the “lump breaker”. This press has a nip which is formed by a wire roll and by a couch roll. Here, the couch roll is wrapped around by a felt.

The problem with this press is that the felt is overloaded at high production speeds and pressing of the web occurs.

The invention is therefore based on the object of providing a method with a “lump breaker” or a first press, in which sufficient dewatering of the fibrous web can take place even at high production rates.

This object is achieved by a dewatering method, in which the first press, through which the fibrous web is guided after the headbox, is equipped with a double nip. Here, the first press is formed by a wire roll and by two couch rolls which are in each case pressed against the wire roll in order to form a nip. The wire roll is wrapped around by a wire and the couch rolls are wrapped around in each case by a felt. A considerable improvement in the dewatering performance of the first press can be achieved by the double nip of the “lump breaker”.

It is advantageous if the couch rolls are wrapped around by a common felt. It is also appropriate here if the felt is dewatered between the first and the second nip by way of a tubular suction device, in order that the felt runs into the second nip in a state in which it is dry again.

In one favorable embodiment, the fibrous web is transferred without a loose run from the first press into a following shoe press, the web transfer being carried out with the aid of a suction roll or a grooved roll.

Moreover, it is favorable if the fibrous web is heated between the first and the second nip of the first press by a steam blower box. The viscosity of the water which is contained can be modified by the heating of the moist fibrous web, as a result of which the dewatering in the second nip is aided.

The subject matter of this invention is also formed by a corresponding device as claimed in one of claims 6 to 10 for carrying out the method.

In the following text, the invention will be described using drawings, in which:

FIG. 1 shows a conventional dewatering device according to the prior art,

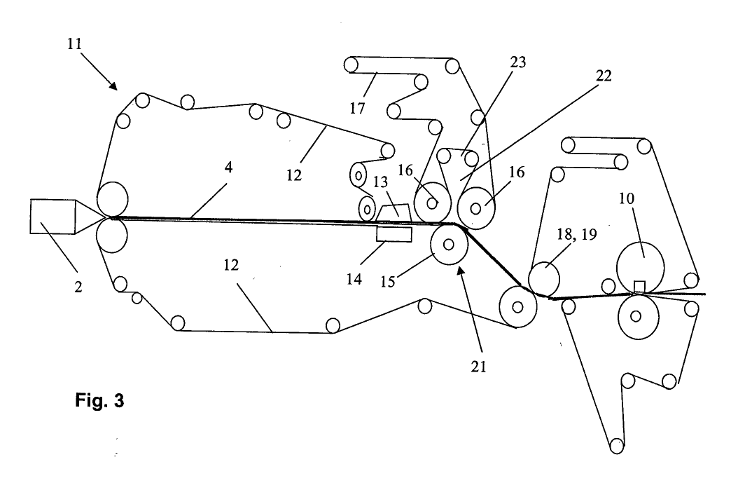

FIG. 2 shows a diagrammatic illustration of the dewatering device according to the invention, and

FIG. 3 shows a further variant of the dewatering device according to the invention.

Identical designations in the respective figures denote identical components.

FIG. 1 shows a dewatering device 1 according to the prior art. The fibrous stock suspension is sprayed in between the wires 3 of the wire section by a head box 2. As a result, a fibrous web 4 is formed which is dewatered in a first press 8, what is known as the “lump breaker”. Said first press 8 comprises a wire roll 5 and couch roll 6, the couch roll being wrapped around by the felt 7. The felt 7 is overloaded at high production speeds, and the dewatering of the fibrous web 4 is then no longer satisfactory.

Further presses 9 and 10, by way of which the fibrous web 4 can be dewatered further, are arranged downstream of the first press 8.

FIG. 2 shows the dewatering device 11 according to the invention. Here too, a fibrous stock suspension is sprayed in between the two wires 12 via a headbox 2. It is of course also conceivable that said dewatering device has only a bottom wire. The first press 21 is configured as a double nip press. It therefore comprises three rolls 15, 16, namely a wire roll 15 and two couch rolls 16. The two couch rolls 16 bear against the wire roll 15 and thus form a first nip and a second nip. The wire roll 15 is preferably evacuated and is wrapped around by the wire 12. In the present example, the two couch rolls 16 are wrapped around by a common felt 17, but it is also conceivable that each couch roll 16 is wrapped around by a dedicated felt. In the present example, a tubular suction device 23 for sucking the felt 17 dry is arranged between the two couch rolls 16. Moreover, a steam blower box 22 for heating the fibrous web 4 is likewise arranged between the two couch rolls 16.

A suction box 14 and a steam blower box 13 are situated upstream of the first press 21. A shoe press 10 is arranged downstream of the first press, and the fibrous web 4 is transferred here in a free run from the first press 21 into the shoe press 10.

During operation, the fibrous web 4 is dewatered downstream of the wire section by the two press nips of the first press 21, and in the process the felt 17 absorbs moisture from the fibrous web 4 in each press nip; in the case of an evacuated wire roll 15, moreover, moisture is also discharged via the wire roll 15.

FIG. 3 shows a similar dewatering device 11 to that shown in FIG. 2, but here the fibrous web 4 is transferred from the first press 21 into the following press (shown here as a shoe press 10) without a free run, that is to say with permanent web support. Here, the web transfer from the wire 12 to the following fabric of the shoe press 10 is carried out with the aid of a suction roll 18 or a grooved roll 19.

1. A method for dewatering a fibrous web, fibrous material for the formation of a fibrous web being introduced via a headbox between two wires and being dewatered, and, following the wire section, the fibrous web which is produced being guided through a plurality of presses and being dewatered, wherein the first press, through which the fibrous web is guided after the headbox, is equipped with a double nip, the first press is formed here by a wire roll and by two couch rolls which are in each case pressed against the wire roll in order to form a nip, the wire roll being wrapped around by a wire and the couch rolls being wrapped around in each case by a felt.

2. The method for dewatering a fibrous web as claimed in claim 1, wherein the couch rolls are wrapped around by a common felt.

3. The method as claimed in claim 2, wherein the felt is dewatered between the first and the second nip of the first press by way of a tubular suction device.

4. The method as claimed in claim 1, wherein the fibrous web is transferred without a loose run from the first press into a following shoe press, the web transfer being carried out with the aid of a suction roll or a grooved roll.

5. The method as claimed in claim 1, wherein the fibrous web is heated between the first and the second nip of the first press by a steam blower box.

6. A device for dewatering a fibrous web with a headbox and a wire section comprising two wires, at least one first press, through which the fibrous web is guided, being arranged downstream of the wire section, wherein the first press is equipped with a double nip, the first press being formed by a wire roll and by two couch rolls which are in each case pressed against the wire roll in order to form a nip, the wire roll being wrapped around by a wire and the couch rolls being wrapped around in each case by a felt.

7. The device as claimed in claim 6, wherein the couch rolls are wrapped around by a common felt.

8. The device as claimed in claim 6, wherein a tubular suction device for sucking the felt to dryness is arranged between the first and the second nip of the first press.

9. The device as claimed in claim 6, wherein a suction roll or a grooved roll is arranged for the web transfer between the first press and a following shoe press.

10. The device as claimed in claim 6, wherein a steam blower box is installed between the first and second nip of the first press.
